(19) United States
(12) Patent Application Publication
(10) Pub. No.: US 2014/0155526 A1
(43) Pub. Date: Jun. 5, 2014

(54) POLYIMIDE COMPOSITION VARNISH, FILM USING THE SAME, AND METHOD OF MANUFACTURING THE POLYIMIDE COMPOSITION VARNISH

(71) Applicant: SAMSUNG DISPLAY CO., LTD., Yongin-City (KR)

(72) Inventor: Fusaki FUJIBAYASHI, Yongin-City (KR)

(73) Assignee: SAMSUNG DISPLAY CO., LTD., Yongin-City (KR)

(21) Appl. No.: 14/094,872

(22) Filed: Dec. 3, 2013

(30) Foreign Application Priority Data
Dec. 3, 2012 (JP) 2012-264312

(51) Int. Cl. C09D 7/12

(52) U.S. Cl. CPC C09D 7/1225
USPC 524/111; 524/154

(57) ABSTRACT

A polyimide composition varnish, a film prepared from the same, and a method of manufacturing a polyimide composition varnish, the polyimide composition varnish including a polyimide or a polyimide precursor; and an organically modified layered silicate in which interlayer ions are replaced with organic phosphonium ions.

### CROSS-REFERENCE TO RELATED APPLICATION

Japanese Patent Application No. 2012-264312, filed on Dec. 3, 2012, in the Japanese Patent Office, and entitled: “POLYIMIDE COMPOSITION VARNISH, FILM USING THE SAME, AND METHOD OF MANUFACTURING THE POLYIMIDE COMPOSITION VARNISH,” is incorporated by reference herein in its entirety.

### BACKGROUND

1. Field

Embodiments relate to a polyimide composition varnish, a film using the same, and a method of manufacturing the polyimide composition varnish.

2. Description of the Related Art

Various flexible devices using a transparent plastic film as a substrate instead of a glass substrate has been considered. Examples of the flexible device may include a flexible organic electroluminescence (EL) display apparatus, a film-type solar cell, and electronic paper. High heat resistance and dimensional stability may be required for manufacturing processes of the above devices.

Semi-aromatic polyimide or fully aliphatic polyimide have been considered as a material for a flexible device due to their excellent colorless transparency and good heat resistance. Also, composites between polyimide and a compound having the form of an inorganic layer have been considered for the purpose of improving the dimensional stability.

### SUMMARY

Embodiments are directed to a polyimide composition varnish, a film using the same, and a method of manufacturing the polyimide composition varnish.

The embodiments may be realized by providing a polyimide composition varnish including a polyimide or a polyimide precursor; and an organically modified layered silicate in which interlayer ions are replaced with organic phosphonium ions.

The polyimide composition varnish may further include an organic solvent, the organic solvent including at least one of γ-butyrolactone, N-methylpyrrolidone, or N, N-dimethylacetamide.

A sum of amounts of the polyimide or the polyimide precursor and the organically modified layered silicate may be in a range of 3 parts by weight to 40 parts by weight, based on a total weight of the polyimide composition varnish.

The organically modified layered silicate may be included in an amount of 1 part by weight to 100 parts by weight, based on 100 parts by weight of the polyimide or the polyimide precursor.

The polyimide composition varnish may further include an organic solvent, the organic solvent including at least one of γ-butyrolactone, N-methylpyrrolidone, or N, N-dimethylacetamide.

A sum of amounts of the polyimide or the polyimide precursor and the organically modified layered silicate may be in a range of 3 parts by weight to 40 parts by weight, based on a total weight of the polyimide composition varnish.

The embodiments may also be realized by providing a film prepared from the polyimide composition varnish according to an embodiment.

A light transmittance at 400 nm may be 80% or more, a haze value may be 5% or less, a linear thermal expansion coefficient at a temperature of 100° C. to 300° C. may be 30 ppm/K or less, and a heating weight loss at 350° C. may be 0.5% or less, based on an original weight measured at 150° C.

The embodiments may also be realized by providing a method of manufacturing a polyimide composition varnish, the method including forming a dispersion by dispersing a layered silicate in water while heating; forming an organically modified layered silicate by adding organic phosphonium ions to the dispersion and stirring, removing a supernatant by separating a solid and a liquid, adding a mixed solution of water and ethanol and stirring, and removing a supernatant by separating a solid and a liquid; forming an organically modified layered silicate dispersion by adding an organic solvent to the organically modified layered silicate and stirring; and adding the organically modified layered silicate dispersion to a polyimide or a polyimide precursor and mixing.

The organic solvent may include at least one of γ-butyrolactone, N-methylpyrrolidone, or N, N-dimethylacetamide.

1 part by weight to 100 parts by weight of the organically modified layered silicate may be added and mixed, based on 100 parts by weight of the polyimide or the polyimide precursor.

The organic solvent may include at least one of γ-butyrolactone, N-methylpyrrolidone, or N, N-dimethylacetamide.

A sum of amounts of the polyimide or the polyimide precursor and the organically modified layered silicate may be in a range of 3 parts by weight to 40 parts by weight, based on a total weight of the polyimide composition varnish.

### DETAILED DESCRIPTION

Example embodiments will now be described more fully hereinafter; however, they may be embodied in different forms and should not be construed as limited to the embodiments set forth herein. Rather, these embodiments are provided so that this disclosure will be thorough and complete, and will fully convey exemplary implementations to those skilled in the art.

The embodiments provide a polyimide composition varnish, in which a layered silicate treated with organic phosphonium ions is dispersed in polyimide. Such a polyimide composition varnish may form a film having improved thermal decomposition resistance as well as good optical properties, heat resistance, and dimensional stability.

Hereinafter, a polyimide composition varnish according to an embodiment, a film using the same, and a method of manufacturing the polyimide composition varnish will be described. However, the polyimide composition varnish according to the embodiment, the film using the same, and the method of manufacturing the polyimide composition varnish may be embodied in many different forms and should not be construed as being limited to the embodiments set forth herein.

The polyimide composition varnish according to the embodiment may include a polyimide or a polyimide precursor and an organically modified layered silicate in which at least some of the interlayer ions are exchanged or replaced with organic phosphonium ions. The polyimide composition varnish according to the embodiment may form a film having improved thermal decomposition resistance as well as good optical properties, heat resistance, and dimensional stability by uniformly dispersing the organically modified layered silicate, in which the interlayer ions are exchanged or replaced with the organic phosphonium ions, in the polyimide or the polyimide precursor. For example, the layered silicate may include organic phosphonium ions in an interlayer thereof. For example, the layered silicate may include organic phosphonium ions intercalated between layers thereof.

The polyimide that may be used in the polyimide composition varnish according to the embodiment may be obtained by, e.g., reacting an aliphatic tetracarboxylic acid or a derivative thereof with a diamine. Examples of the aliphatic tetracarboxylic acid or the derivative thereof may include an aliphatic tetracarboxylic acid, aliphatic tetracarboxylic acid esters, and an aliphatic tetracarboxylic acid dianhydride. According to an embodiment, an aliphatic tetracarboxylic acid dianhydride may be used as the aliphatic tetracarboxylic acid or the derivative thereof. An aliphatic diamine or an aromatic diamine may be used as the diamine, and also, a mixture thereof may be used.

Examples of the aliphatic tetracarboxylic acid dianhydride may include 1,2,4,5-cyclopentane tetracarboxylic acid dianhydride, 1,2,4,5-cyclohexane tetracarboxylic acid dianhydride, bicyclo[2,2,2]oct-7-ene-2,3,5,6-tetracarboxylic acid dianhydride, 3,3′,4,4′-biphenyl tetracarboxylic acid dianhydride, 3,3′,4,4′-benzophenone tetracarboxylic acid dianhydride, 3,3′,4,4′-biphenylether tetracarboxylic acid dianhydride, 3,3′,4,4′-biphenylsulfone tetracarboxylic acid dianhydride, 2,2′-bis(3,4-dicarboxyphenyl)hexafluoropropane acid dianhydride, 2,2′-bis(3,4-dicarboxyphenyl)propane acid dianhydride, 1,4,5,8-naphthalene tetracarboxylic acid dianhydride, 1,2,3,4-butane tetracarboxylic acid dianhydride, 1,2,3,4-cyclobutane tetracarboxylic acid dianhydride, 1,2,3,4-cyclopentane tetracarboxylic acid dianhydride, 1,2,4,5-cyclohexane tetracarboxylic acid dianhydride, 3,3′,4,4′-bicyclohexyl tetracarboxylic acid dianhydride, bicyclo[2.2.1]heptane-2,3,5,6-tetracarboxylic acid dianhydride, 2,3,4,5-tetrahydrofuran tetracarboxylic acid dianhydride, bicyclo[2,2,2]oct-7-ene-2,3,5,6-tetracarboxylic acid dianhydride, and bicyclo[2.2.2]octane-2,3,5,6-tetracarboxylic acid dianhydride. In an implementation, a 1,2,4,5-cyclohexane tetracarboxylic acid dianhydride may be used as the aliphatic tetracarboxylic acid dianhydride. The aliphatic tetracarboxylic acid dianhydrides may be used alone or in a mixture of two or more thereof. In an implementation, a 1,2,4,5-cyclohexane tetracarboxylic acid dianhydride may be used alone.

Examples of the aliphatic diamine may include 4,4′-diaminodicyclohexylmethane, isophoronediamine, ethylenediamine, tetramethylenediamine, norbornanediamine, p-xylenediamine, 1,3-bis(aminomethyl)cyclohexane, 1,3-diaminocyclohexane, hexamethylenediamine, polyethylene glycol bis(3-aminopropyl)ether, m-xylenediamine, 4,4′-methylene bis(cyclohexylamine), bicyclohexyldiamine, siloxanediamine, trans-1,4-diaminocyclohexane, 1,4-cyclohexane bis(methylamine), 2,5-bis(aminomethyl)bicyclo[2.2.1]heptane, 2,6-bis(aminomethyl)bicyclo[2.2.1]heptane, 3,8-bis(aminomethyl)tricyclo[5.2.1.0]decane, 1,3-diaminoadamantane, 2,2-bis(4-aminocyclohexyl)propane, 2,2-bis(4-aminocyclohexyl)hexafluoropropane, 1,3-propanediamine, 1,4-tetramethylenediamine, 1,5-pentamethylenediamine, 1,6-hexamethylenediamine, 1,7-heptamethylenediamine, 1,8-octamethylenediamine, 1,9-nonamethylenediamine, 4,4′-diaminocyclohexylmethane, 4,4′-diamino-3,3′-dimethyldicyclohexylmethane, 3(4),8(9)-bis(aminomethyetricyclo[5,2,1,02,6]decane, 2,5(6)-bis(aminomethyl)bicyclo[2,2,1]heptane, isophoronediamine, 1,3-bis(aminomethyl)cyclohexane, 1,3-diaminocyclohexane, 1,4-diaminocyclohexane, 1,2-diaminoethane, 1,4-diaminobutane, 1,5-diaminopentane, 1,6-diaminohexane, and 1,8-diaminooctane. The above diamines may be used alone or in a mixture of two or more thereof. In an implementation, with respect to diamines having an aliphatic ring structure, such as 4,4′-diaminocyclohexylmethane, isophoronediamine, and 1,3-diaminocyclohexane, polymerization may be facilitated and heat resistance may be excellent, the diamines may be appropriately used. The diamines may be used alone or in a mixture of two or more thereof.

Examples of the aromatic diamine may include oxydianiline, diaminodiphenylmethane, 1,3-phenylenediamine, 1,4-phenylenediamine, dimethylbenzidine, dimethoxybenzidine, diaminodiphenylsulfide, diaminodiphenylsulfoxide, diaminodiphenylsulfone, diaminobenzophenone, 2,2-bis(3-aminophenyl)propane, 2,2-bis(4-aminophenyl)propane, 2,2-bis[4-(4-aminophenoxy)phenyl]-1,1,1,3,3,3-hexafluoropropane, 1,4-bis(3-aminophenoxy)benzene, 1,4-bis(4-aminophenoxy)benzene, 1,3-bis(3-aminophenoxy)benzene, 1,3-bis(4-aminophenoxy)benzene, 4,4-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]ethyl, bis[4-(4-aminophenoxy)phenyl]ethyl, p-phenylenediamine, m-phenylenediamine, 2,4-diaminotoluene, 2,5-diaminotoluene, 2,4-diaminoxylene, 2,4-diaminodurene, 4,4′-diaminodiphenylmethane, 4,4′-methylene bis(2-methylaniline), 4,4′-methylene bis(2-ethylaniline), 4,4′-methylene bis(2,6-dimethylaniline), 4,4′-methylene bis(2,6-diethylaniline), 4,4′-diaminodiphenyl ether, 3,4′-diaminodiphenyl ether, 3,3′-diaminodiphenyl ether, 2,4′-diaminodiphenyl ether, 4,4′-diaminodiphenylsulfone, 3,3′-diaminodiphenylsulfone, 4,4′-diaminobenzophenone, 3,3′-diaminobenzophenone, 4,4′-diaminobenzanilide, benzidine, 3,3′-dihydroxybenzidine, 3,3′-dimethoxybenzidine, o-tolidine, m-tolidine, 2,2′-bis(trifluoromethyl)benzidine, 1,4-bis(4-aminophenoxy)benzene, 1,3-bis(4-aminophenoxy)benzene, 1,3-bis(3-aminophenoxy)benzene, 4,4′-bis(4-aminophenoxy)biphenyl, bis(4-(3-aminophenoxy)phenyl)sulfone, bis(4-(4-aminophenoxy)phenyl)sulfone, 2,2-bis(4-(4-aminophenoxy)phenyl)propane, 2,2-bis(4-(4-aminophenoxy)phenyl)hexafluoropropane, 2,2-bis(4-aminophenyl)hexafluoropropane, p-terphenylenediamine, 4,4′-diaminobiphenyl, 4,4′-diamino-2,2′-bis(trifluoromethyl)biphenyl, and 4,4′-diaminodiphenyl sulfide. The above diamines may be used alone or in a mixture of two or more thereof.

In an implementation, the polyimide that may be used in the polyimide composition varnish according to an embodiment may include a polyimide polymer that is obtained by imidization of at least one selected from the group of pyromellitic acid dianhydride and 9,9-bis(4′-hydroxyphenyl)fluorene-bis(trimellitate anhydride) with 4,4-methylene bis(cyclohexylamine) and isophoronediamine.

the organic phosphonium ions that may be used in the polyimide composition varnish according to the embodiment may be provided by a tetraalkyl phosphonium salt having at least one alkyl chain with a total carbon number of 4 to 100. In an implementation, the tetraalkyl phosphonium salt may have at least one alkyl chain with a total carbon number of 6 to 50, e.g., the tetraalkyl phosphonium salt may have at least one alkyl chain with a total carbon number of 8 to 36. The alkyl chain may be a straight chain group or a branched chain group.

Examples of the branched alkyl that may be used as a substituent of the tetraalkyl phosphonium salt may include a 2-butyl octyl group, a 2-hexyl decyl group, a 2-octyl dodecyl group, a 2-decyl tetradecyl group, a 2-dodecyl hexadecyl group, a 2-tetradecyl octadecyl group, a 2-hexadecyl icosyl group, a 3,5,5-trimethyl hexyl group, 3,7-dimethyl octyl group, and 3,7,11,15-tetramethyl hexadecyl group. The branched alkyl may be an alkyl chain that is branched at two positions, e.g., a 2-butyl octyl group, a 2-hexyl decyl group, a 2-octyl dodecyl group, 2-decyl tetradecyl group, a 2-dodecyl hexadecyl group, a 2-tetradecyl octadecyl group, or a 2-hexadecyl icosyl group. In an implementation, the branched alkyl may be a 2-hexadecyl icosyl group.

In an implementation, the branched alkyl may include, e.g., an unsaturated bond (double bond or triple bond), an ester group, an amide group, an ethyl group, or a phenylene group at a portion of the alkyl group. The tetraalkyl phosphonium salts with a branched alkyl having a total carbon number of 9 or more may be used alone or in combination of a plurality thereof. In an implementation, the number of the branched alkyls may be one.

A compound in which three long chain alkyl groups are bonded to a ring atom, may be used as the tetraalkyl phosphonium salt. With respect to the tetraalkyl phosphonium salt having three long chain alkyl groups, a carbon number of each alkyl chain may independently be in a range of about 4 to about 100. In an implementation, the carbon number of each alkyl chain may independently be in a range of about 6 to about 50, e.g., the carbon number of each alkyl chain may independently be in a range of about 8 to about 36.

Examples of the tetraalkyl phosphonium salt may include tetraethyl phosphonium bromide, tetrabutyl phosphonium bromide, tetrabutyl phosphonium chloride, tetrabutyl phosphonium iodide, tributyloctyl phosphonium bromide, tributyldodecyl phosphonium bromide, tributylhexadecyl phosphonium bromide, trioctylethyl phosphonium bromide, triethylbenzyl phosphonium chloride, tributylmethyl phosphonium iodide, tributylaryl phosphonium bromide, tributylbenzyl phosphonium chloride, trioctylvinylbenzyl phosphonium chloride, tributyl 2-methylaryl phosphonium chloride, trioctyl 2-methylaryl phosphonium chloride, dimethyldioctadecyl phosphonium chloride, dimethyldioctadecyl phosphonium bromide, dimethyloctadecylbenzyl phosphonium chloride, dimethyloctadecylbenzyl phosphonium bromide, tetraphenyl phosphonium bromide, triphenylbenzyl phosphonium chloride, triphenylmethyl phosphonium bromide, triphenylbutyl phosphonium bromide, bis(hydroxypropyl) octadecyl isobutyl phosphonium chloride, triphenylcarboxyethyl phosphonium bromide, and triphenylcarboxypenthyl phosphonium bromide.

In an implementation, the layered silicate that may be used in the polyimide composition varnish may include, e.g., a clay mineral having swelling property and/or cleavability or a hydrotalcite compound and an analogous compound thereof. Examples of the clay mineral may include kaolinite, dickite, nacrite, halloysite, antigorite, crysotile, pyrophyllite, montmorillonite, beidellite, nontronite, saponite, sauconite, stevensite, hectorite, tetrasilicic-mica, sodium tenorite, muscovite, margarite, talc, vermiculite, phlogopite, xanthophyllite, and chlorite. The layered silicate may include a natural product or a synthetic product. In an implementation, the layered silicates may be used alone or two or more thereof.

A shape of the layered silicate is not particularly limited. According to an embodiment, when the layered silicate stacks as a multilayer, cleavage of the layered silicate may be difficult after the layered silicate is organically modified. Therefore, a thickness of the layered silicate that is not organically modified may be a thickness of one layer (e.g., about 1 nm). Also, an average length of the layered silicate may be in a range of about 0.01 μm to about 50 μm. In an implementation, the average length of the layered silicate may be in a range of about 0.05 μm to about 10 μm. In an implementation, an aspect ratio of the layered silicate may be in a range of about 20 to about 500, e.g., the aspect ratio of the layered silicate may be in a range of about 50 to about 200.

The layered silicate may have ion-exchangeable inorganic cations between layers. Examples of the ion-exchangeable inorganic cations may include metal ions such as sodium, potassium, and lithium ions. The layered silicate may include the above ions, the layered silicate may have ion-exchangeability with a cationic material, and may intercalate organic phosphonium ions between layers.

A cation exchange capacity (CEC) of the layered silicate is not particularly limited and may be in a rage of about 10 meq/100 g to about 200 meq/100 g. In an implementation, the CEC of the layered silicate may be in a rage of about 50 meq/100 g to about 150 meq/100 g, e.g., the CEC of the layered silicate may be in a rage of about 90 meq/100 g to about 130 meq/100 g. Maintaining the CEC of the layered silicate at about 10 meq/100 g or greater may help prevent a decrease in an amount of the organic phosphonium ions intercalated between the layers of the layered silicate by ion exchange, thus ensuring sufficient organic modification of the interlayer. Maintaining the CEC of the layered silicate at about 200 meq/100 g or less may help prevent an excessive increase in the bonding force between the layers of the layered silicate, thus facilitating exfoliation of crystal flakes.

In an implementation, the layered silicate may be a synthetic product, e.g., fine raw material powders of zirconium oxide, boron oxide, and carbon may be mixed and the layered silicate may be then obtained by heating the mixture thus obtained at about 1,000° C. in a neutral or reducing atmosphere.

The polyimide composition varnish according to an embodiment may include the organically modified layered silicate, in which the interlayer ions are exchanged or replaced with the organic phosphonium ions, in an amount of about 1 part by weight to about 100 parts by weight, based on 100 parts by weight of the above-described polyimide or polyimide precursor. In an implementation, the polyimide composition varnish according to an embodiment may include the organically modified layered silicate in an amount of about 5 parts by weight to about 75 parts by weight, based on 100 parts by weight of the polyimide or the polyimide precursor. Accordingly, a film having improved optical properties, heat resistance, dimensional stability, and thermal decomposition resistance may be formed.

In an implementation, the polyimide composition varnish according to an embodiment may further include an organic solvent. In an implementation, the organic solvent may include at least one of γ-butyrolactone, N-methylpyrrolidone, or N, N-dimethylacetamide. The solvent may be used in a mixture of two or more thereof. According to an embodiment, the organic solvent may be used as a solvent by which polyimide is synthesized or the organically modified layered silicate is dispersed in the polyimide or the polyimide precursor. The organically modified layered silicate may be uniformly dispersed in the polyimide or the polyimide precursor.

According to an embodiment, a sum of amounts of the polyimide or the polyimide precursor and the organically modified layered silicate, in which the interlayer ions are exchanged or replaced with the organic phosphonium ions, may be in a range of about 3 parts by weight to about 40 parts by weight, based on a total weight of the polyimide composition varnish. In an implementation, the sum of the amounts of the polyimide or the polyimide precursor and the organically modified layered silicate may be in a range of about 5 parts by weight to about 20 parts by weight, based on the total weight of the polyimide composition varnish. Maintaining the sum of the amounts of the polyimide or the polyimide precursor and the organically modified layered silicate at about 3 parts by weight or greater may help prevent the viscosity of the final polyimide composition varnish from being excessively low, thus facilitating formation of a stable film in terms of the thickness of the film. Maintaining the sum of the amounts of the polyimide or the polyimide precursor and the organically modified layered silicate at about 40 parts by weight or less may help prevent an excessive increase in the viscosity of the final polyimide composition varnish, thus facilitating formation of a stable film in terms of the state of a surface. In view of the above, the polyimide composition varnish according to an embodiment may be uniformly dispersed.

Method of Manufacturing Polyimide Composition Varnish

A method of manufacturing the above-described polyimide composition varnish according to an embodiment will be described below.

According to an embodiment, a polyimide composition varnish may be obtained by uniformly mixing polyimide or a polyimide precursor and an organically modified layered silicate dispersion. For example, a dispersion may be prepared by dispersing a layered silicate in water (e.g., distilled water or ultrapure water) while heating. Organic phosphonium ions (e.g., salts) may be added to the dispersion and stirred, and a supernatant may then be removed by separating a solid and a liquid. A mixed solution of water and ethanol may be added to a gel-type product thus obtained and stirred, and a gel-type product of an organically modified layered silicate may be obtained by again removing a supernatant by separating a solid and a liquid. An operation, in which a mixed solution of water and ethanol is again added to the gel-type product and stirred, and a supernatant is then removed by separating a solid and a liquid, may be repeated until a concentration of sodium ions of the supernatant is below a measurement or desired limit. Thus, a gel-type product of an organically modified layered silicate may be obtained.

An organic solvent may be added to the gel-type product of an organically modified layered silicate thus obtained and stirred to prepare the organically modified layered silicate dispersion. The organically modified layered silicate dispersion may be added to a varnish containing polyimide or a polyimide precursor and mixed. In this case, mixing may be performed to uniformly disperse the organically modified layered silicate in the polyimide or the polyimide precursor. Also, the polyimide may be obtained by reacting the above-described aliphatic tetracarboxylic acid or the derivative thereof with a diamine. Thus, the above-described organic solvent may be used as a solvent during the reaction.

According to an embodiment, the organically modified layered silicate may be added in an amount of about 1 part by weight to about 100 parts by weight, based on 100 parts by weight of the polyimide or the polyimide precursor and mixed. In an implementation, the organically modified layered silicate may be added in an amount of about 5 parts by weight to about 75 parts by weight, based on 100 parts by weight of the polyimide or the polyimide precursor and mixed. A sum of the amounts of the polyimide or the polyimide precursor and the organically modified layered silicate may be in a range of about 3 parts by weight to about 40 parts by weight, based on a total weight of the polyimide composition varnish. In an implementation, the sum of the amounts of the polyimide or the polyimide precursor and the organically modified layered silicate may be in a range of about 5 parts by weight to about 20 parts by weight.

As described above, the polyimide composition varnish according to an embodiment may form a film having improved optical properties, heat resistance, dimensional stability, and thermal decomposition resistance by uniformly dispersing the organic layered silicate (in which the interlayer ions are exchanged with the organic phosphonium ions) in the polyimide or the polyimide precursor.

Film

A film may be prepared from or using the above-described polyimide composition varnish according to an embodiment. For example, a substrate may be coated with the polyimide composition varnish according to an embodiment, in which an organically modified layered silicate is uniformly dispersed in polyimide or a polyimide precursor, and heated to form a film.

The film according to an embodiment may have certain properties. For example, a light transmittance at 400 nm may be about 80% or more, a haze value may be about 5% or less, a linear thermal expansion coefficient at a temperature of about 100° C. to about 300° C. may be about 30 ppm/K or less, and a heating weight loss at about 350° C. may be about 0.5% or less, based on or compared to a heating weight loss at about 150° C. (e.g., compared to an original weight determined at 150° C.). When the light transmittance at 400 nm is about 80% or more, and/or the haze value is about 5% or less, the obtained film may exhibit excellent optical properties and may replace a glass substrate. When the linear thermal expansion coefficient at a temperature of about 100° C. to about 300° C. is about 30 ppm/K or less, the film may be suitably used as a substrate for an electronic material. When the heating weight loss at about 350° C. is about 0.5% or less, stable production may be achieved because contamination of a vacuum system may be reduced and/or prevented during a manufacturing process of a device. As a result, the use of such a film may be possible.

Other polyimide films (in which a layered silicate organically modified with an alkyl ammonium salt or alkyl imidazolium salt is used) may satisfy colorless transparency and dimensional stability. However, thermal decomposition resistance, e.g., a heating weight loss, may not be considered. Therefore, other polyimide composition varnishes may have low thermal decomposition resistance and may contaminate the vacuum system during the manufacturing process of the device. In contrast, the polyimide composition varnish according to an embodiment may provide a film having excellent thermal decomposition resistance as well as excellent optical properties, heat resistance, and dimensional stability. The film may replace a glass substrate and may be used in various flexible devices, e.g., a flexible organic electroluminescence (EL) display apparatus, a film-type solar cell, or electronic paper.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

A polyimide composition varnish according to an embodiment will be described in more detail with reference to examples.

A. Polyimide or Polyimide Precursor

A-1

About 21.14 g (0.1 mol) of 4,4-diaminocyclohexylmethane (Wako Pure Chemical Industries, Ltd.), about 54.54 g of N-methyl-2-pyrrolidone (Kishida Chemical Co., Ltd.) as an organic solvent, and about 13.60 g of N,N-dimethylacetamide (Kishida Chemical Co., Ltd.) were put into a 500 mL five-neck flask including a thermometer, a stirrer, a nitrogen injection ring, and a cooling tube equipped with a classifier and dissolved. A mixed solution thus obtained was cooled at about 5° C. by using an ice water bath. About 22.62 g (0.1 mol) of 1,2,4,5-cyclohexane tetracarboxylic acid dianhydride (Iwatani Industrial Gases Corp.) and about 0.50 g (0.005 mol) of triethylamine (Tokyo Chemical Industry Co., Ltd.) as an imidization catalyst were added together to the mixed solution while being maintained at the same temperature. Lumps of salt thus formed were uniformly dissolved by increasing a temperature to about 130° C. and stirring for about 30 minutes. Thereafter, the temperature was increased to about 180° C., and a solution thus obtained was refluxed for about 6 hours while a distillate was removed each time by distillation. Then, the temperature was increased to about 200° C. to complete a reaction, and the solution was cooled in air until an inner temperature became about 100° C. A polyimide varnish (A−1) having a concentration of about 10 wt % was obtained by cooling the solution while N,N-dimethylacetamide as a dilution solvent was added thereto and stirred.

A-2

About 13.45 g (60 mmol) of 1,2,4,5-cyclohexane tetracarboxylic acid dianhydride (Iwatani Industrial Gases Corp.), about 45 g of γ-butyrolactone, and about 0.95 g (12 mmol) of pyridine (Wako Pure Chemical Industries, Ltd.) were put into a 300 mL separable flask under the flow of nitrogen. A temperature in a system was increased to about 80° C. to about 90° C., and a mixture was stirred until the 1,2,4,5-cyclohexane tetracarboxylic acid dianhydride was completely dissolved. About 12.0 g (60 mmol) of 4,4′-diaminodiphenylether (ODA; 4,4′-oxydianiline) (JFE Chemical) was added thereto after the complete dissolution of the 1,2,4,5-cyclohexane tetracarboxylic acid dianhydride was confirmed. Then, about 35 g of toluene was added thereto and simultaneously, water generated from a reaction was removed to the outside of the system by an azeotrope with toluene. The removal of the water as an azeotrope was conducted for about 3 hours, and the reaction was then continued for about 1 hour by introducing a terminal blocking agent. Thereafter, a solution thus obtained was cooled in air until an inner temperature became about 100° C. A polyimide varnish (A-2) having a concentration of about 10 wt % was obtained by cooling the solution while γ-butyrolactone as a dilution solvent was added thereto and stirred.

A-3

4,4′-methylenebis(cyclohexylamine) (about 9.5 mmol) and isophoronediamine (about 0.5 mmol) were dissolved in N,N-dimethylacetamide in a sealed reaction vessel equipped with a fully dried stirrer, and pyromellitic acid dianhydride powder (about 10 mmol) was slowly added thereto. Then, a transparent and viscous polyimide varnish (A-3) having a concentration of about 10 wt % was obtained by being stirred at room temperature for about 2 hours.

B. Organically Modified Layered Silicate Dispersion

B-1

About 10 g of synthetic saponite (Sumecton SA, Kunimine Industries Co., Ltd.,) as a layered silicate was added to about 1,000 g of distilled water, and a dispersion was obtained by dispersing and swelling with a magnetic stirrer while being heated to about 70° C. Then, about 10.68 g of commercial hexyltriphenyl phosphonium bromide (Tokyo Chemical Industry Co., Ltd.) was added to the dispersion, and a solution thus obtained was then further stirred for about 2 hours. Then, solid-liquid separation was performed by using a centrifuge at about 10,000 rpm for about 15 minutes. A separated supernatant was removed, and a mixed solution of distilled water/ethanol (=40/60) was then added thereto so that a total volume became about 500 cm³ and stirred. Solid-liquid separation was again performed by using a centrifuge under the above conditions after the stirring, and a separated supernatant was again removed. The stirring and the centrifugation were repeated until a concentration of sodium ions of the supernatant was about 1 ppm or less. The product obtained by the above method was a layered silicate (hexyltriphenyl phosphonium modified layered silicate), in which gel-type hexyltriphenyl phosphonium including water having a solid content of about 10% and ethanol was included.

Next, about 50 g of γ-butyrolactone was added to about 50 g of the obtained layered silicate, in which the gel-type hexyltriphenyl phosphonium including water having a solid content of about 10% and ethanol was included, and a uniform dispersion was obtained by stirring a mixture at about 5,000 rpm for about 60 minutes using an Ace homogenizer (AM-001, Nihonseiki Kaisha Ltd.). Water and ethanol were distilled while depressurizing and stirring the obtained dispersion, and thus, about 50 g of a 10% organically modified layered silicate dispersion (B−1) was obtained.

B-2

About 50 g of a 10% organically modified layered silicate dispersion (B-2) was prepared in the same manner as in B-1 except that trioctylmethyl phosphonium bromide (Tokyo Chemical Industry Co., Ltd.) was used instead of hexyltriphenyl phosphonium bromide.

B-3

About 50 g of a 10% organically modified layered silicate dispersion (B-3) was prepared in the same manner as in B-1 except that trioctylmethyl ammonium bromide (Tokyo Chemical Industry Co., Ltd.) was used instead of hexyltriphenyl phosphonium bromide.

B-4

A 10% organically modified layered silicate dispersion (B-4) was prepared by adding about 45 g of γ-butyrolactone to about 5 g of synthetic smectite (STN, Corp. Chemical Co., Ltd.) which was organically modified by using a trioctylmethyl ammonium salt, and stirring a mixture at about 5,000 rpm for about 60 minutes using the Ace homogenizer (AM-001, Nihonseiki Kaisha Ltd.).

### Example 1

A uniform solution was prepared by adding about 5 g of the organically modified layered silicate dispersion (B−1) to about 20 g of the polyimide varnish (A−1) and stirring a mixture at about 5,000 rpm for about 60 minutes using the Ace homogenizer (AM-001, Nihonseiki Kaisha Ltd.). A glass support substrate was coated with the solution, and pre-drying was performed at about 100° C. for about 30 minutes in a nitrogen purged oven. Then, a film was formed by heating the glass support substrate to about 350° C. and holding for about 60 minutes. After cooling, an about 15 μm thick film was obtained by exfoliating the film from the glass support substrate.

### Examples 2 to 5 and Comparative Examples 1 to 5

Films were prepared in the same manner as in Example 1, except that the polyimide varnishes A-1 to A-3 and the organically modified layered silicate dispersions B-1 to B-4 were mixed in compositions listed in Tables 1 and 2, below.

### Example 6 and Comparative Examples 6 and 7

Types and amounts of (A) polyimide varnish and (B) organically modified layered silicate were used as listed in Table 3, below, and glass support substrates were coated with uniform solutions by the same manner as in Example 1. Thereafter, the glass support substrates were pre-dried at about 60° C. on a hot plate and then transferred to a nitrogen purged oven. Then, films were formed by heating the glass support substrates from room temperature to about 350° C. and holding for about 60 minutes. After cooling, about 15 μm thick films were obtained by exfoliating the films from the glass support substrates.

Thermal decomposition resistance, dimensional stability, light transmittance at 400 nm, and haze were analyzed on the films of the examples and comparative examples.

Thermal Decomposition Resistance

The analysis of the thermal decomposition resistance was performed by a method in which the temperature was increased from room temperature to about 600° C. at a heating rate of about 10° C./minute in a nitrogen atmosphere using EXSTAR TG/DTA6200 (Seiko Instruments Inc.), and a weight reduction ratio at about 400° C. was obtained based on an original weight at about 150° C.

Dimensional Stability

The analysis of the dimensional stability was performed by a method in which the temperature was increased from room temperature to about 400° C. at a heating rate of about 5° C./minute in a nitrogen atmosphere using TMA8310 (Rigaku Corporation), changes in dimension (size) were measured in a tensile mode under a load of about 45 mN, and a linear thermal expansion coefficient in a temperature range of about 100° C. to about 300° C. was calculated.

Light Transmittance

The analysis of the light transmittance (400 nm) was performed by measuring light transmittance at a wavelength of about 400 nm using a UV-2200 spectrophotometer (equipped with an integrating sphere, Shimazu Corporation).

Haze

The analysis of the haze was performed by measuring total light transmittance (Tt) and diffuse transmittance (Td) in a wavelength of about 380 nm to about 780 nm using a UV-2200 spectrophotometer (equipped with an integrating sphere, Shimazu Corporation) and calculating a haze value according to the following equation.

Haze (%)=Td/Tt×100

Compositions and characteristics of the films of the Examples and Comparative Examples are presented in Tables 1 to 3.

TABLE 1

| | | | | Comparative | Comparative | Comparative |
|---|---|---|---|---|---|---|
| | | Example 1 | Example 2 | Example 1 | Example 2 | Example 3 |
| (A) Polyimide or | | A-1 | A-1 | A-1 | A-1 | A-1 |
| polyimide | | 20 g | 20 g | 20 g | 20 g | 20 g |
| precursor varnish | | | | | | |
| (B) Organically | | B-1 | B-2 | — | B-3 | B-4 |
| modified layered | | 5 g | 5 g | — | 5 g | 5 g |
| silicate dispersion | | | | | | |
| Film Characteristics | Film thickness | 15 | 14 | 12 | 15 | 14 |
| | (μm) | | | | | |
| | Thermal | 0.29 | 0.31 | 0.28 | 5.6 | 15.2 |
| | decomposition | | | | | |
| | resistance (%) | | | | | |
| | Dimensional | 18.3 | 19.8 | 59.3 | 23.6 | 24.6 |
| | stability | | | | | |
| | (ppm/K) | | | | | |
| | Light | 86.5 | 86.8 | 87.2 | 83.3 | 84.1 |
| | transmittance | | | | | |
| | (400 nm) (%) | | | | | |
| | Haze (%) | 0.2 | 0.2 | 0.1 | 0.3 | 0.4 |

TABLE 2

| | | | | | Comparative | Comparative |
|---|---|---|---|---|---|---|
| | | Example 3 | Example 4 | Example 5 | Example 4 | Example 5 |
| (A) Polyimide or | | A-1 | A-1 | A-2 | A-2 | A-2 |
| polyimide | | 20 g | 20 g | 20 g | 20 g | 20 g |
| precursor varnish | | | | | | |
| (B) Organically | | B-1 | B-1 | B-1 | — | B-3 |
| modified layered | | 1.05 g | 14 g | 5 g | — | 5 g |
| silicate dispersion | | | | | | |
| Film Characteristics | Film thickness | 12 | 13 | 15 | 13 | 14 |
| | (μm) | | | | | |
| | Thermal | 0.28 | 0.41 | 0.33 | 0.32 | 6.6 |
| | decomposition | | | | | |
| | resistance (%) | | | | | |
| | Dimensional | 28.8 | 11.2 | 21.1 | 63.3 | 25.6 |
| | stability | | | | | |
| | (ppm/K) | | | | | |
| | Light | 87.1 | 85.3 | 85.3 | 86.5 | 83.2 |
| | transmittance | | | | | |
| | (400 nm) (%) | | | | | |
| | Haze (%) | 0.1 | 1.1 | 0.3 | 0.3 | 0.5 |

TABLE 3

| | | | Com- | Com- |
|---|---|---|---|---|
| | | | parative | parative |
| | | Example 6 | Example 6 | Example 7 |
| (A) Polyimide or | | A-3 | A-3 | A-3 |
| polyimide precursor | | 20 g | 20 g | 20 g |
| varnish | | | | |
| (B) Organically modified | | B-1 | — | B-3 |
| layered silicate dispersion | | 5 g | — | 5 g |
| Film | Film thickness (μm) | 13 | 13 | 14 |
| Characteristics | Thermal | 0.43 | 0.41 | 8.6 |
| | decomposition | | | |
| | resistance (%) | | | |
| | Dimensional | 17.3 | 53.8 | 19.8 |
| | stability | | | |
| | (ppm/K) | | | |
| | Light transmittance | 83.2 | 83.5 | 80.3 |
| | (400 nm) (%) | | | |
| | Haze (%) | 0.4 | 0.2 | 0.9 |

Table 1 presents the results of Examples 1 and 2 and Comparative Examples 1 to 3 obtained from the films that were formed by dispersing different types of the organically modified layered silicate dispersions B-1 to B-4 in the same amount of the polyimide varnish (A−1). Examples 1 and 2 exhibited excellent thermal decomposition resistance, dimensional stability, light transmittance at 400 nm, and haze. It may be seen that the film of Comparative Example 1, which was only formed of the polyimide varnish (A−1), exhibited significantly worse dimensional stability. It may be seen that thermal decomposition resistances were significantly worse and dimensional stabilities were also worse with respect to Comparative Example 2, in which the layered silicate dispersion (B-3) organically modified using a trioctylmethyl ammonium salt was used, and Comparative Example 3 in which the organically modified layered silicate (B-4) was used. Also, haze values of Comparative Examples 2 and 3 were increased.

Table 2 presents the results of Examples 3 and 4 obtained from the films that were formed by dispersing different amounts of the organically modified layered silicate dispersion (B−1) in the same amount of the polyimide varnish (A−1) as in Examples 1 and 2. Dimensional stability was reduced in Example 3, in which an amount of the added organically modified layered silicate dispersion (B−1) was small. With respect to Example 4, in which the amount of the added organically modified layered silicate dispersion (B−1) was large, dimensional stability was improved, but a haze value was increased.

Table 2 also presents the results of Example 5 and Comparative Examples 4 and 5 obtained from the films that were formed by dispersing different types of the organically modified layered silicate dispersions B-1 and B-3 in the same amount of the polyimide varnish (A-2). Example 5 exhibited excellent thermal decomposition resistance, dimensional stability, light transmittance at 400 nm, and haze. It may be seen that the film of Comparative Example 4, which was only formed of the polyimide varnish (A-2), exhibited significantly of Example 3 dimensional stability. It may be seen that thermal decomposition resistance was significantly of Example 3 and dimensional stability was also of Example 3 with respect to Comparative Example 5, in which the layered silicate dispersion (B-3) organically modified using a trioctylmethyl ammonium salt was used. Also, a haze value of Comparative Example 5 was increased.

Table 3 presents the results of Example 6 and Comparative Examples 6 and 7 obtained from the films that were formed by dispersing different types of the organically modified layered silicate dispersions B-1 and B-3 in the same amount of the polyimide varnish (A-3). Example 6 exhibited excellent thermal decomposition resistance, dimensional stability, light transmittance at 400 nm, and haze. It may be seen that the film of Comparative Example 6, which was only formed of the polyimide varnish (A-3), exhibited significantly of Example 3 dimensional stability. It may be seen that thermal decomposition resistance was significantly of Example 3 and dimensional stability was also of Example 3 with respect to Comparative Example 7, in which the layered silicate dispersion (B-3) organically modified using a trioctylmethyl ammonium salt was used. Also, a haze value of Comparative Example 7 was increased.

As described above, it may be seen that all of the films formed by using the polyimide composition varnish according to an embodiment had excellent characteristics of thermal decomposition resistance, dimensional stability, light transmittance at 400 nm, and haze in comparison to a typical film.

By way of summation and review, colorless transparency and dimensional stability may be observed without thermal decomposition resistance, e.g., a heating weight loss. An actual manufacturing process of a device may include a vacuum process at a high temperature, and there a material that does not contaminate a vacuum system may be desirable.

The embodiments may provide a film having excellent optical properties, dimensional stability, and thermal decomposition resistance.

The embodiments may provide a film having improved thermal decomposition resistance as well as good optical properties, heat resistance, and dimensional stability.

The polyimide composition varnish according to an embodiment may form a film having improved thermal decomposition resistance as well as good optical properties, heat resistance, and dimensional stability.

According to an embodiment, a film having improved thermal decomposition resistance as well as good optical properties, heat resistance, and dimensional stability, a polyimide composition varnish used in the film, and a method of manufacturing the polyimide composition varnish may be provided.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A polyimide composition varnish, comprising:
a polyimide or a polyimide precursor; and
an organically modified layered silicate in which interlayer ions are replaced with organic phosphonium ions.

2. The polyimide composition varnish as claimed in claim 1, further comprising an organic solvent, the organic solvent including at least one of γ-butyrolactone, N-methylpyrrolidone, or N, N-dimethylacetamide.

3. The polyimide composition varnish as claimed in claim 2, wherein a sum of amounts of the polyimide or the polyimide precursor and the organically modified layered silicate is in a range of 3 parts by weight to 40 parts by weight, based on a total weight of the polyimide composition varnish.

4. The polyimide composition varnish as claimed in claim 1, wherein the organically modified layered silicate is included in an amount of 1 part by weight to 100 parts by weight, based on 100 parts by weight of the polyimide or the polyimide precursor.

5. The polyimide composition varnish as claimed in claim 4, further comprising an organic solvent, the organic solvent including at least one of γ-butyrolactone, N-methylpyrrolidone, or N, N-dimethylacetamide.

6. The polyimide composition varnish as claimed in claim 5, wherein a sum of amounts of the polyimide or the polyimide precursor and the organically modified layered silicate is in a range of 3 parts by weight to 40 parts by weight, based on a total weight of the polyimide composition varnish.

7. A film prepared from the polyimide composition varnish as claimed in claim 1.

8. The film as claimed in claim 7, wherein:
a light transmittance at 400 nm is 80% or more,
a haze value is 5% or less,
a linear thermal expansion coefficient at a temperature of 100° C. to 300° C. is 30 ppm/K or less, and
a heating weight loss at 350° C. is 0.5% or less, based on an original weight measured at 150° C.

9. A method of manufacturing a polyimide composition varnish, the method comprising:
forming a dispersion by dispersing a layered silicate in water while heating;
forming an organically modified layered silicate by adding organic phosphonium ions to the dispersion and stirring, removing a supernatant by separating a solid and a liquid, adding a mixed solution of water and ethanol and stirring, and removing a supernatant by separating a solid and a liquid;
forming an organically modified layered silicate dispersion by adding an organic solvent to the organically modified layered silicate and stirring; and
adding the organically modified layered silicate dispersion to a polyimide or a polyimide precursor and mixing.

10. The method as claimed in claim 9, wherein the organic solvent includes at least one of γ-butyrolactone, N-methylpyrrolidone, or N, N-dimethylacetamide.

11. The method as claimed in claim 9, wherein 1 part by weight to 100 parts by weight of the organically modified layered silicate is added and mixed, based on 100 parts by weight of the polyimide or the polyimide precursor.

12. The method as claimed in claim 11, wherein the organic solvent includes at least one of γ-butyrolactone, N-methylpyrrolidone, or N, N-dimethylacetamide.

13. The method as claimed in claim 9, wherein a sum of amounts of the polyimide or the polyimide precursor and the organically modified layered silicate is in a range of 3 parts by weight to 40 parts by weight, based on a total weight of the polyimide composition varnish.
